(19) United States
(12) Patent Application Publication
(10) Pub. No.: US 2013/0135331 A1
(43) Pub. Date: May 30, 2013

(54) PROJECT-DATA CREATING DEVICE AND PROGRAMMABLE DISPLAY DEVICE

(71) Applicant: Kengo Koara, Chiyoda-ku (JP)

(72) Inventor: Kengo Koara, Chiyoda-ku (JP)

(73) Assignee: Mitsubishi Electric Corporation, Chiyoda-ku, Tokyo (JP)

(21) Appl. No.: 13/574,156

(22) PCT Filed: Nov. 30, 2011
(86) PCT No.: PCT/JP11/77673

§ 371 Date: Jul. 19, 2012

(51) Int. Cl. G09G 5/00

(52) U.S. Cl. 345/581

(57) ABSTRACT

To execute a stable pressure control, in a control device for an injection molding machine, a filling/pressure-keeping determining unit determines whether the injection molding machine is performing a pressure keeping operation, an elastic constant identifier acquires, when the filling/pressure-keeping determining unit determines that the pressure keeping operation is in progress, a pressure detection value and a position detection value as operation information of a motor and identifies an elastic constant K based on the acquired pressure detection value and the position detection value, and a pressure-control control-parameter setting unit calculates a proportional gain Ka of a pressure controller such that a product of the proportional gain Ka of the pressure controller and the elastic constant K is smaller than a speed control bandwidth ωsc of a speed controller, and sets the calculated proportional gain Ka to the pressure controller.

### FIELD

The present invention relates to a project-data creating device and a programmable display device.

### BACKGROUND

On a production line in a factory, for example, there are facilities having a plurality of programmable display devices that have a substantially identical screen configuration from one another but refer to different external connection devices or display different objects in some part on their screens. Drawing data of these programmable display devices needs to be designed individually.

Conventionally, in a case of designing drawing data of such facilities, it has been common to create model drawing data, to copy it for use, and then modify changed portions of the data. In this case, however, when the model drawing data is modified, it is necessary to reflect the modification on each of the copied drawing data, which requires a lot of much time and labor, and raises a possibility of causing such a problem that some copied drawing data may not be modified. Furthermore, to find the difference between one modified drawing data and another modified drawing data, it is necessary to open each of the drawing data using drawing software and open each object or each function setting screen for comparison, so that these processes are considerably difficult to perform.

To cope with such problems, it has been required to efficiently create drawing data of programmable display devices having similar screens and functions, and also to facilitate management when a modification needs to be made.

Patent Literature 1 prepares, in designing a screen for a programmable display device, a “template” that corresponds to the model mentioned above, and mainly focuses on allocation of devices. Patent Literature 1, however, provides parameter-memory allocation information to manage and define parameters to be reflected on various settings, and also refers to the fact that unnecessary buttons are deleted (undisplayed) according to the screen configuration.

Patent Literature 2 proposes, in a plant monitoring device, a system that prepares templates of screens and functions provides customizable items, externally defines setting values corresponding to these items as customized data, and is operated based on the customized data.

### CITATION LIST

### Patent Literatures

Patent Literature 1: Japanese Patent Application Laid-open No. 2004-030345
Patent Literature 2: Japanese Patent Application Laid-open No. 2007-334745

### SUMMARY

### Technical Problem

However, Patent Literature 1 does not clearly disclose a method of specifying attributes for each object unit such as a switch and a lamp, and for example, no solution for handling a modification to the color of the switch or to a string on a nameplate is clearly described.

Furthermore, Patent Literature 2 does not disclose a method of creating templates, and in this point of view, Patent Literature 2 is supposed to be provided on the assumption that screen layouts corresponding to the templates and functions are created in advance by a manufacturer who provides a plant monitoring device, but are not prepared by a screen designer who is the user of the screen, unlike programmable display devices. On the other hand, the programmable display devices are expected that the screen designer can freely create templates, and thus the technique disclosed in Patent Literature 2, which does not disclose a method therefore, cannot be applied to programmable display devices.

In addition, when plural types of screens are switchably displayed on a programmable display device, combinations of various types of screens are different for respective Units of the programmable display device, and thus it is necessary to create, for respective Units of the programmable display device, drawing data including the screens that correspond to each of the plurality of types thereof.

The present invention has been achieved in view of the above problems, and it is an object of the present invention to provide a project-data creating device and a programmable display device that can easily create project data that becomes the basis for drawing data of screens, which respectively have a substantially identical but partially different screen configuration from one another.

### Solution to Problem

In order to overcome the aforementioned problems, the project-data creating device according to one aspect of the present invention, which creates project data that is a basis of drawing data for causing a programmable display device to display a screen including an object and to operate a background function is constructed in such a manner that it includes: a unit that creates a drawing data template including a setting ID and a predetermined attribute name, the setting ID being set for each of the object and the background function included in the drawing data, the predetermined attribute name being set for each attribute value of the object and the background function; a unit that creates project property data including immediate data that corresponds to the attribute name set for each attribute value of the object and the background function corresponding to the setting ID; and a unit that transmits the drawing data template and the project property data to the programmable display device as the project data.

### Advantageous Effects of Invention

The project-data creating device and the programmable display device according to the present invention can easily create project data that becomes the basis for drawing data of screens, which respectively have a substantially identical but partially different screen configuration to one another.

### BRIEF DESCRIPTION OF DRAWINGS

FIG. 1 depicts a configuration of a project-data creating device and a programmable display device according to a first embodiment of the present invention.

FIG. 2 depicts a configuration of the programmable display device.

FIG. 3 depicts functions provided on a computer by drawing software to be executed on the computer.

FIG. 4 is an example of a method of editing project property data.

FIG. 5 is an example of a screen displayed on the programmable display device.

FIG. 6 is an example of drawing data for displaying a screen on a conventional programmable display device.

FIG. 7 is a conceptual explanatory diagram of a problem caused when drawing data is created by conventional programmable display devices.

FIG. 8 depicts a drawing data template in the programmable display device according to the first embodiment.

FIG. 9 is an example of project-property aggregate data according to the first embodiment.

FIG. 10 is another example of the project-property aggregate data.

FIG. 11 is an example of a label-entity correspondence table.

FIG. 12 is still another example of the project-property aggregate data.

FIG. 13 is an example of a drawing data template in which attribute values are defined as the defaults.

FIG. 14 is a schematic diagram of a process of interpreting project property data using drawing software.

FIG. 15 depicts a processing flow in a case where project property data are interpreted by drawing software and drawing data are transmitted to programmable display devices.

FIG. 16 is a schematic diagram of a process in a case where a main unit of a programmable display device interprets project property data.

FIG. 17 depicts a processing flow in a case where programmable display devices interpret project property data.

FIG. 18 depicts combinations of screens and functions displayed on a programmable display device.

FIG. 19 is an example of project-property aggregate data.

### DESCRIPTION OF EMBODIMENTS

Exemplary embodiments of a programmable display device and a project-data creating device according to the present invention will be explained below in detail with reference to the accompanying drawings. The present invention is not limited to the embodiments.

### First Embodiment

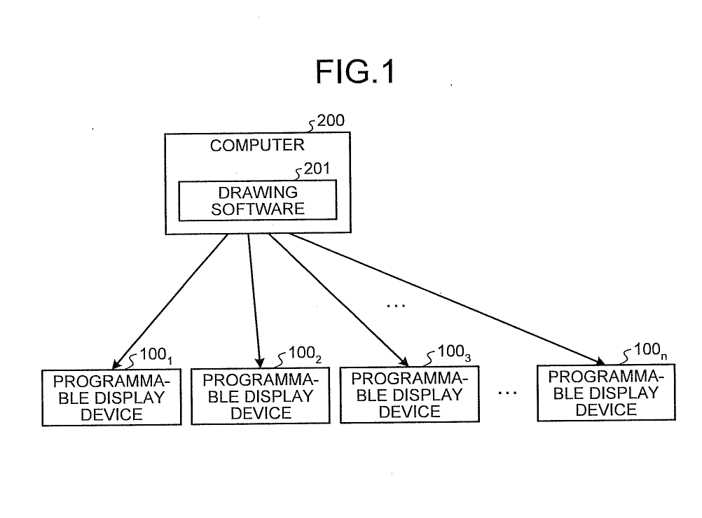

FIG. 1 depicts a configuration of a project-data creating device and a programmable display device according to a first embodiment of the present invention. A plurality of programmable display devices 100₁ to 100ₙ, which respectively correspond to Unit 1 to Unit n, are installed on a production line in a factory and the like, so as to log the outputs from external devices such as a PLC, display status of the devices and to control facilities. A computer 200 serving as the project-data creating device executes drawing software 201 for creating a drawing data template and project property data, thereby to create project data that becomes the basis for drawing data for each of the plural programmable display devices 100₁ to 100ₙ. In the following explanations, the programmable display devices 100₁ to 100ₙ are simply referred to as “programmable display device 100” when matters common to the programmable display devices 100₁ to 100ₙ are explained and the devices do not need to be explained separately.

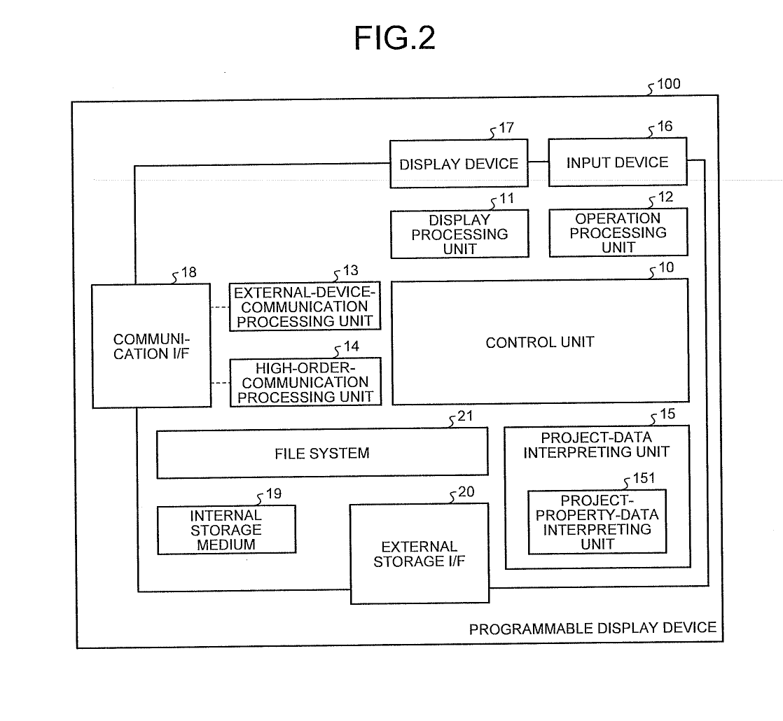

FIG. 2 depicts a configuration of the programmable display device 100. The programmable display device 100 includes a control unit 10, a display processing unit 11, an operation processing unit 12, an external-device communication processing unit 13, a high-order communication processing unit 14, a project-data interpreting unit 15, an input device 16, a display device 17, a communication I/F 18, an internal storage medium 19, an external storage I/F 20, and a file system 21.

The control unit 10 determines an operation of the programmable display device 100 and instructs an update of display to the display processing unit 11, based on drawing data obtained when the project-data interpreting unit 15 interprets project property data or drawing data downloaded from the computer 200 via the communication I/F 18 and the external-device communication processing unit 13, and also based on an operational input obtained from the input device 16, and information on an external device (a PLC, for example) obtained from the external-device communication processing unit 13. Furthermore, when a communication request is issued from the drawing software 201 via the high-order-communication processing unit 14, the control unit 10 switches the status of the programmable display device 100 as necessary (restarts the system, for example). The control unit 10 stores therein a Unit number for specifying the programmable display device 100 that the control unit 10 belongs to.

The display processing unit 11 creates screen display contents according to instructions from the control unit 10. The display processing unit 11 also controls the display device 17 (an LCD, for example).

The operation processing unit 12 notifies the control unit 10 of an input operation from the input device 16 (a touch panel, for example).

The external-device communication processing unit 13 communicates with an external device to perform reading and writing with devices included in the external device.

The high-order communication processing unit 14 controls communications with a high-order system such as a computer, including a project-data creating device.

The project-data interpreting unit 15 includes a project-property-data interpreting unit 151 which reflects information set as project property data in project data on a drawing data template. In the following explanations, reflecting information set as the project property data on the drawing data template is referred to also as “interpreting the project property data”.

The internal storage medium 19 stores therein project data and drawing data downloaded from the computer 200 in a non-volatile manner, as described later.

As described later, when the drawing software is used to interpret the project property data and create the drawing data in advance, the project-property-data interpreting unit 151 of the programmable display device 100 is not used.

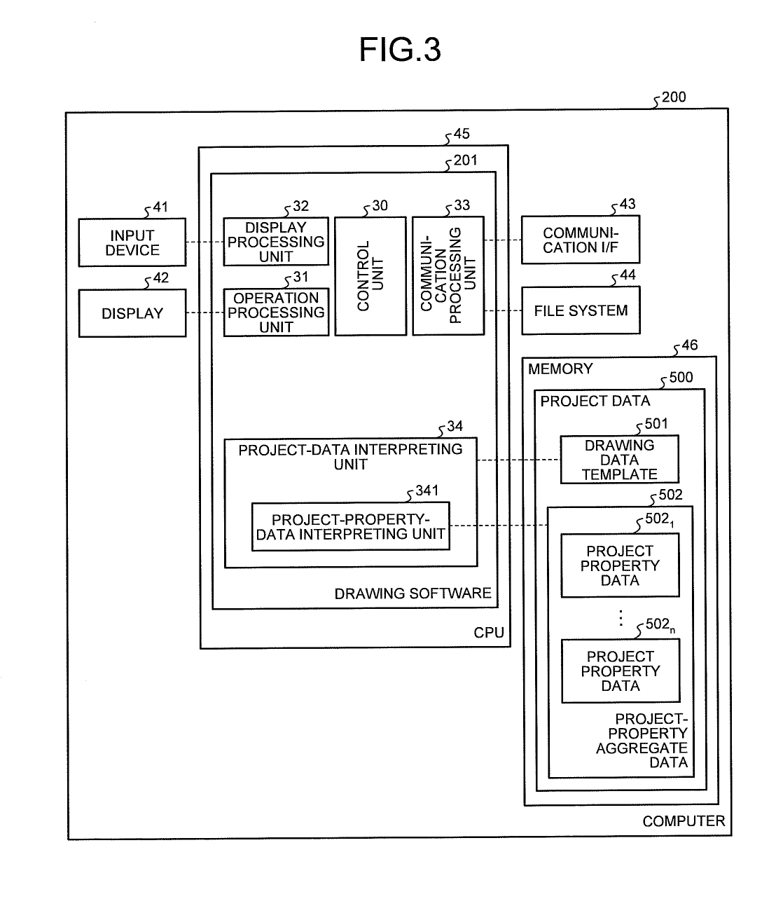

FIG. 3 depicts functions provided on the computer 200 by the drawing software 201 executed on the computer 200. The computer 200 is a general computer 200 including an input device 41 such as a mouse and a keyboard, a display 42, a communication I/F 43, a file system 44, a CPU 45, and a memory 46. The computer 200 that executes the drawing software 201 includes a control unit 30, an operation processing unit 31, a display processing unit 32, a communication processing unit 33, and a project-data interpreting unit 34.

The control unit 30 provides menus and functions of the drawing software 201, based on the contents of operations obtained from the operation processing unit 31 and information obtained from the project-data interpreting unit 34.

The operation processing unit 31 detects user operations transmitted via the input device 41.

The display processing unit 32 creates contents displayed on the display 42, such as menus and an editing screen provided by the drawing software 201.

The communication processing unit 33 provides a function of communicating with the programmable display device 100 via the communication I/F 43. The communication processing unit 33 is used to communicate with the programmable display device 100 to read and write information including project data 500. Furthermore, the communication processing unit 33 has a function of reading and writing information accessible by the programmable display device 100, including the project data 500 stored in an external storage medium such as a memory card, via the file system 44.

The project-data interpreting unit 34 creates the project data 500 (a drawing data template 501 and project-property aggregate data 502) in response to an input operation transmitted via the input device 41, and stores the project data 500 in the memory 46. Furthermore, a project-property-data interpreting unit 341 reflects information set in project property data 502₁ to 502ₙ included in the project-property aggregate data 502 on the drawing data template 501. That is, the project-property-data interpreting unit 341 interprets the project property data 502₁ to 502ₙ. The project property data 502₁ to 502ₙ have attribute values defined for each of the programmable display devices 100₁ to 100ₙ. The following description exemplifies a case where the project property data 502₁ to 502ₙ are handled together as the project-property aggregate data 502; however, it is needless to mention that the project property data 502₁ to 502ₙ can be handled separately.

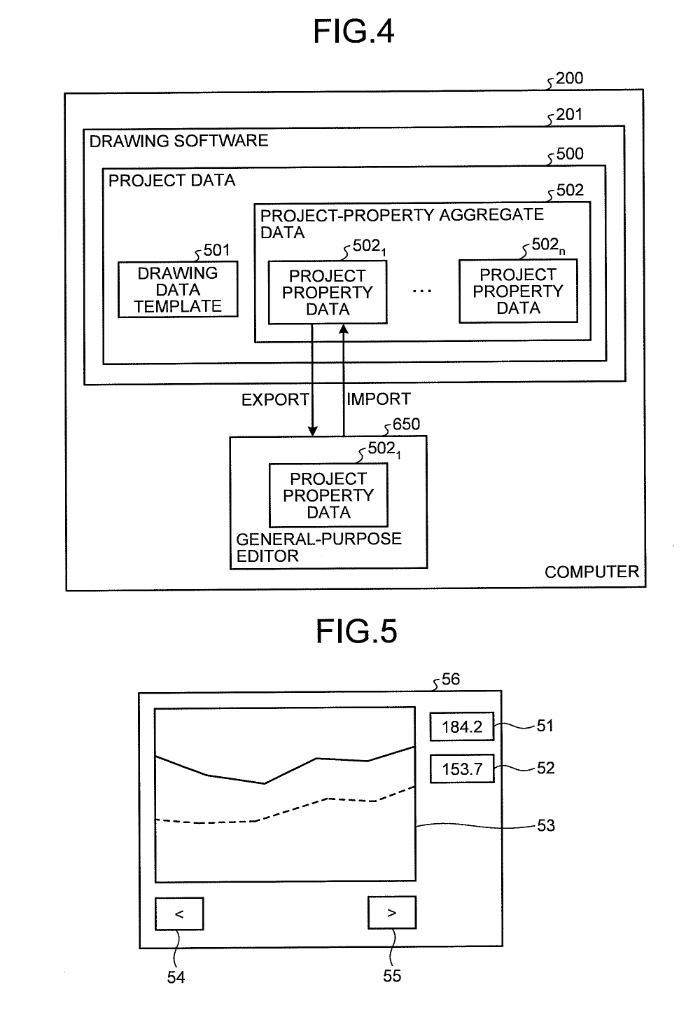

FIG. 4 is an example of a method of editing the project property data 502₁ to 502ₙ. Among the project data 500 created by the drawing software 201, the project property data 502₁ to 502ₙ each having attribute values defined therefor can be exported as an external file and edited by a general-purpose editor 650 (a spreadsheet application, a text editor and the like). The project property data 502₁ to 502ₙ edited by the general-purpose editor 650 can be used when the attribute values of the project data 500 are updated (when the project property data 502₁ to 502ₙ are interpreted), by importing the project property data 502₁ to 502ₙ to the drawing software 201.

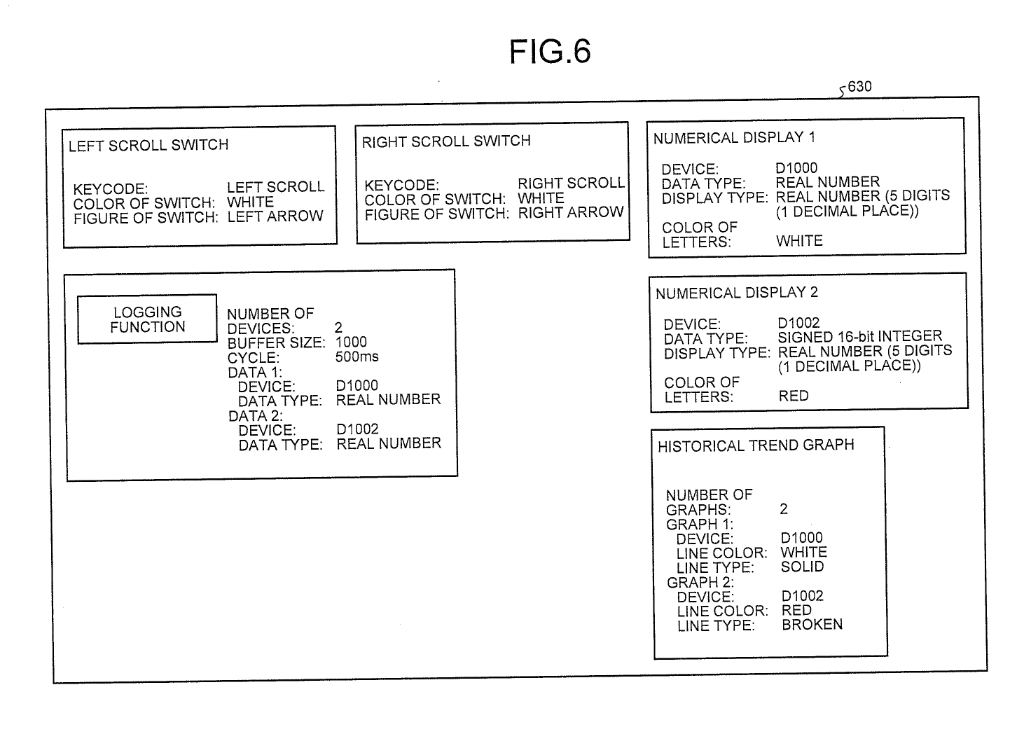

FIG. 5 is an example of a screen displayed on the programmable display device. FIG. 6 is an example of drawing data for displaying a screen on a conventional programmable display device, in which drawing data for displaying the screen shown in FIG. 5 is exemplarily used. The conventional programmable display device executes the drawing data 630, thereby displaying a screen 56 including a numerical-value display column 51, a numerical-value display column 52, a historical trend graph 53, a left-scroll switch 54, and a right-scroll switch 55 on a display device. By executing the drawing data 630, the conventional programmable display device logs the outputs from two devices, which are “D1000” and “D1002”.

Now let us consider a case in which various attributes (a device, a line color, a line type and the like) of the drawing data 630 shown in FIG. 6 are set differently for respective Units. Specifically, the configuration of the screen 56 shown in FIG. 5 is a screen of the programmable display device 100 as a specific Unit incorporated in a certain production apparatus, and it is assumed that the device used by that specific Unit is different from that of another Unit, and assumed that it is necessary to add or delete an object (an indication of numerical values in this example) depending on the configuration of the production apparatus.

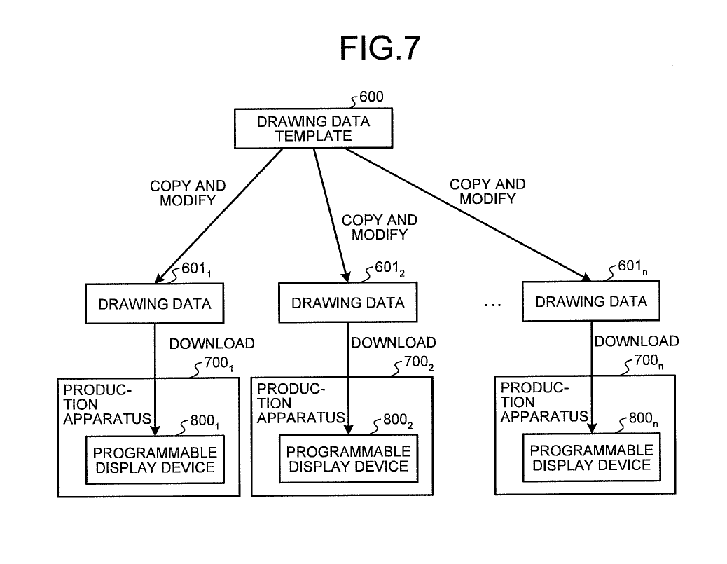

FIG. 7 is a conceptual explanatory diagram of a problem caused when drawing data is created by conventional programmable display devices 800₁ to 800ₙ. When a drawing data template 600 is modified according to production apparatuses 700₁ to 700ₙ and then downloaded to the programmable display devices 800₁ to 800ₙ, drawing data 601₁ to 601ₙ are created by n times of editing, which is same as the number of the production apparatuses, and are then downloaded to the programmable display devices 800₁ to 800ₙ. When the drawing data template 600 is further modified (revised), the same modification work should be done for each of the plural elements of drawing data 601₁ to 601ₙ created based on the drawing data template 600 before being revised. This requires a number of man-hours and likely to cause operational mistakes such as omission of modifications.

Furthermore, in order to confirm differences of the specification among the drawing data 601₁ to 601ₙ created as corresponding to the production apparatuses 700₁ to 700ₙ, it is necessary to open and examine the drawing data 601₁ to 601ₙ individually.

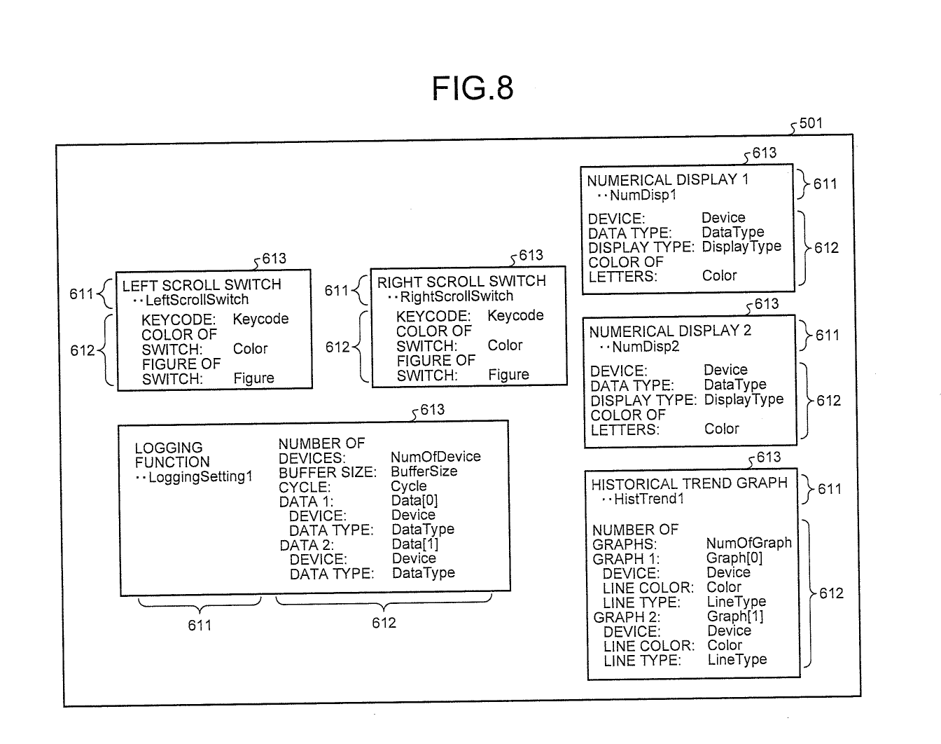

FIG. 8 depicts the drawing data template 501 in the programmable display device 100 according to the first embodiment. The drawing data template 501 is used as a template when the screen 56 shown in FIG. 5 is shown by the programmable display device 100 and then the drawing data for collecting and storing values of two devices by a logging function is created. The project-data interpreting unit 34 of the drawing software 201 creates the drawing data template 501 so as to specify attributes to be modified (attributes of objects or functions) 613 with a setting ID 611 (NumDisp1, LogginSetting1 and the like in this example, which is determined by a user) and an attribute name 612 indicating each attribute (Device, DataType and the like, which is determined in advance for each object and function). That is, the drawing data template 501 includes the setting IDs 611 that are set for each of an object (a numerical display column, a historical trend graph and the like) and a background function (a logging function) included in the drawing data, and also the predetermined attribute names 612 that are set for each attribute value of the object and the background function.

In this manner, the project-data interpreting unit 34 creates the drawing data template 501 that defines the object and the background function, as well as the setting IDs 611 corresponding thereto. As for the attribute values of various functions in the drawing data template 501, they can be omitted. In addition, when the attribute values are set, these values can be used as default attribute values of the drawing data. The logging function has been explained here as an example of the background function; however, other functions such as an alarm function can be made to be operated by the programmable display device 100 as the background function.

In this example, the attribute values are not defined; however, it is also possible to define all the attribute values and to overwrite the values with the project property data 502₁ to 502ₙ. This overwriting is described later.

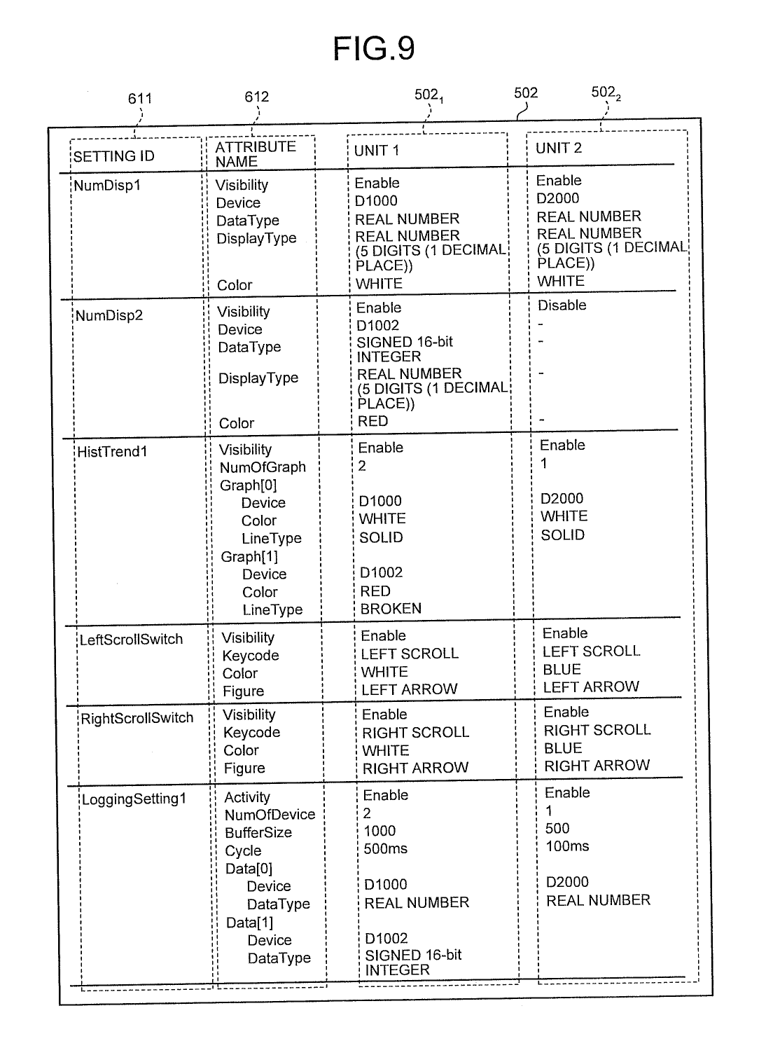

FIG. 9 is an example of the project-property aggregate data 502 according to the first embodiment. The project-property aggregate data 502 is defined by the project-data interpreting unit 34 as an attribute value (immediate data) corresponding to the attribute names 612 for each of the setting IDs 611, in response to the input operation transmitted via the input device 41. That is, the project property data 502₁ to 502ₙ include the immediate data corresponding to the attribute names 612 that are set for each attribute value of the object and the background function specified by the setting IDs 611. This enables the attributes for the plural programmable display devices 100 to be defined together as the project-property aggregate data 502. An attribute “Visibility” is common to each object for controlling displaying and undisplaying of objects, and an object defined as “Disable” is not displayed (disabled). An attribute “Activity” is common to each function of controlling enabling and disabling of functions, and a function defined as “Disable” is not executed.

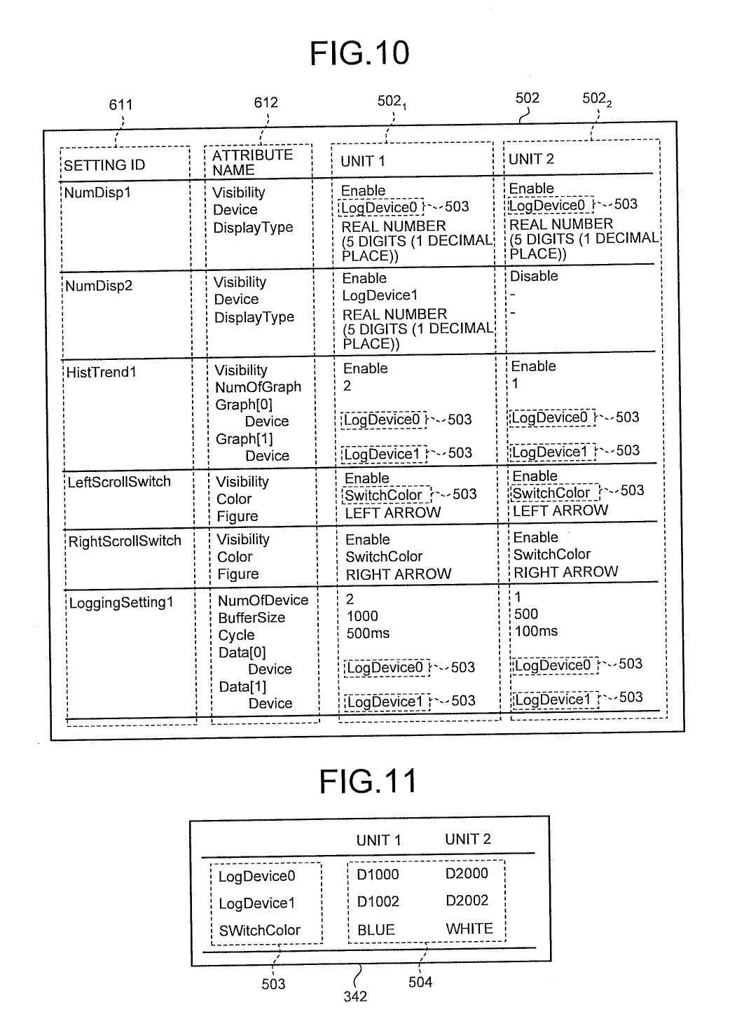

FIG. 10 is another example of the project-property aggregate data 502. When defining the attribute values in the project property data 502₁ to 502ₙ, the project-data interpreting unit 34 can also describe names (labels) 503 for specifying the attribute values for each item, instead of describing immediate data for each item. In this case, the project-data interpreting unit 34 generates and stores therein a label-entity correspondence table 342 in which the label 503 and an entity (an attribute value) 504 corresponding to the label are associated with each other, in response to user operations transmitted via the input device 41. FIG. 11 is an example of the label-entity correspondence table 342. When interpreting the project property data 502₁ to 502ₙ, the project-data interpreting unit 34 and the project-data interpreting unit 15 allocate the attribute value 504 defined in the label-entity correspondence table 342 to the attribute defined by the label 503. This enables association of the attributes having the same attribute value and a collective modification of the attribute values common to the plural programmable display devices 100.

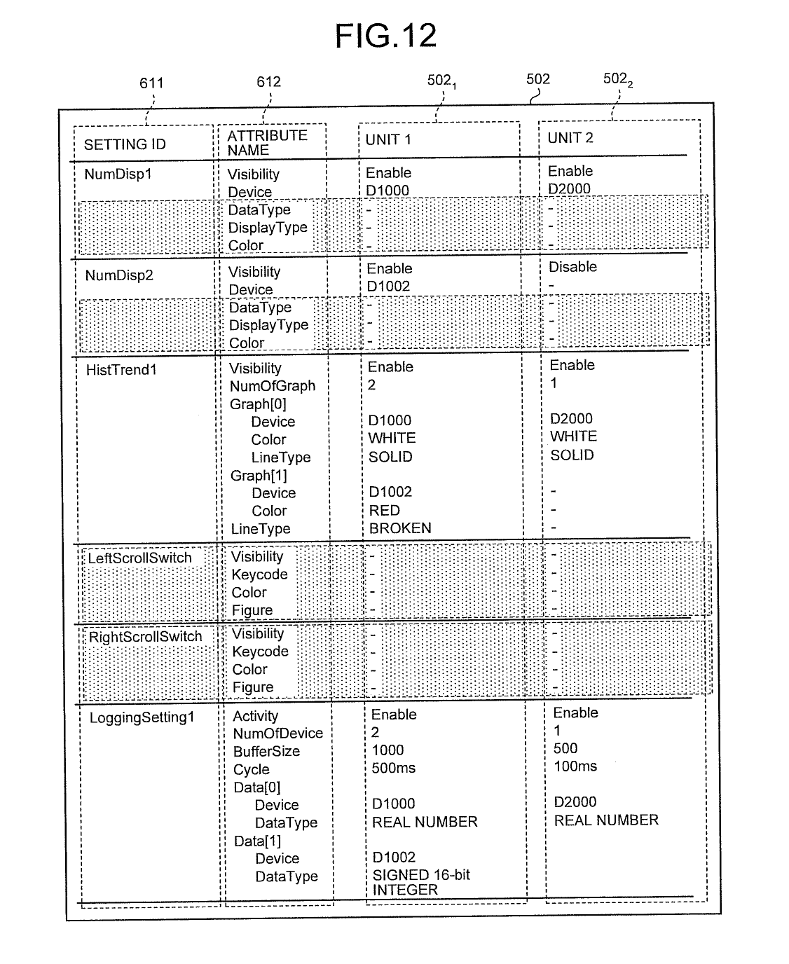

FIG. 12 is still another example of the project-property aggregate data 502. In the project property data 502₁ to 502ₙ, only some attributes can be defined, instead of defining all attributes. For attributes that are not defined in the project property data 502₁ to 502ₙ, the project-data interpreting unit 34 and the project-data interpreting unit 15 use the attribute values defined in the drawing data template 501 as they are, thereby interpreting the project property data 502₁ to 502ₙ. With this configuration, it is possible to define only a minimum number of attribute values different for respective Units in the project property data 502₁ to 502ₙ.

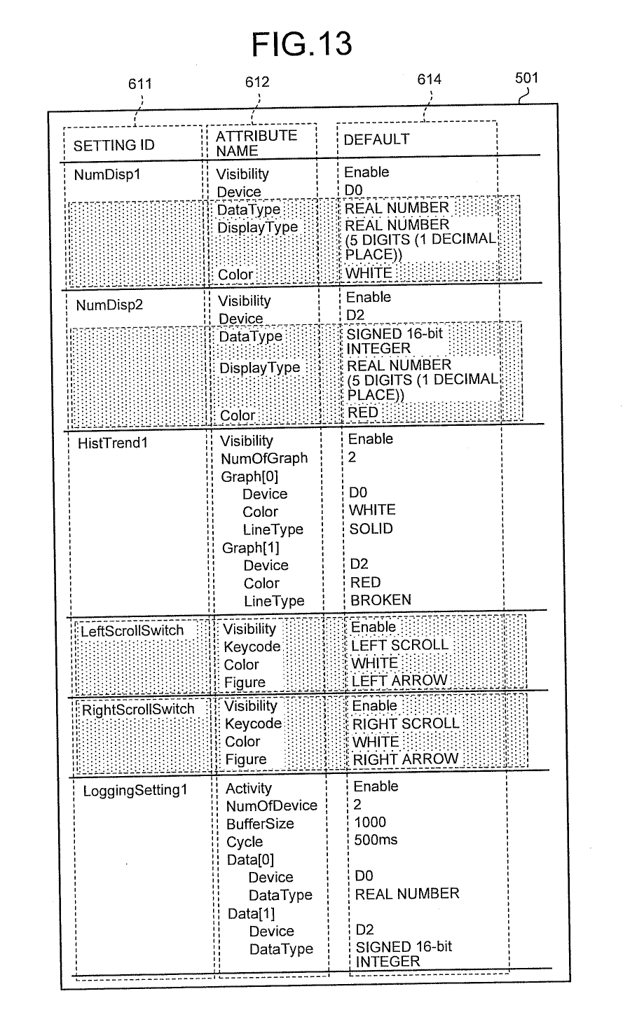

When some of all attributes are defined, it is necessary to define all attribute values not defined in the project property data 502₁ to 502ₙ, as defaults 614 in the drawing data template 501. That is, the attributes not defined in the project property data 502₁ to 502ₙ cannot be treated as undefined in the drawing data template 501. FIG. 13 is an example of the drawing data template 501 in which attribute values are defined as the defaults 614. The attribute values including values not defined in the project property data 501₁ and 502₂ shown in FIG. 12 are defined as the defaults 614.

A process of updating (interpreting) attribute values using the drawing data template 501 and the project property data 502₁ to 502ₙ can take any one of modes of (1) interpreting using the drawing software 201 for creating the project data 500 (interpreting by the project-data interpreting unit 34) and of (2) interpreting by a main unit of the programmable display device 100 (interpreting by the project-data interpreting unit 15).

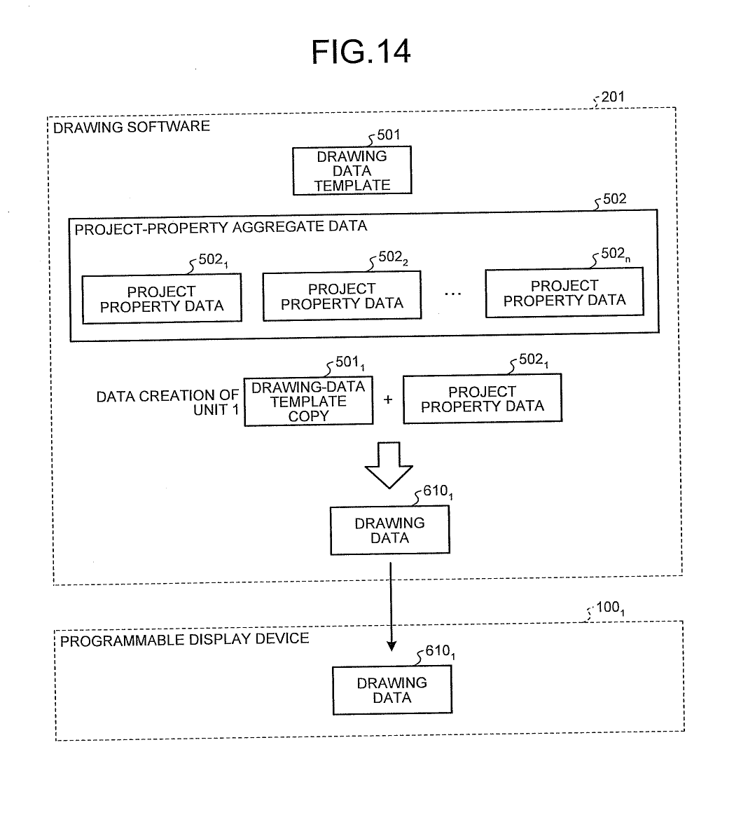

FIG. 14 is a schematic diagram of a process of interpreting the project property data 502 using the drawing software 201. The following explanation exemplifies a case of interpreting the project property data 502₁ and creating drawing data 610₁ for the programmable display device 100₁. When the project property data 502₁ is interpreted by the project-data interpreting unit 34 of the drawing software 201, the drawing data to be held in the programmable display device 100₁ is only the drawing data 610₁ of its own programmable display device 100₁, and compared to a case where the main unit of the programmable display device 100₁ interprets the project property data 502₁, the required memory size can be smaller. Furthermore, at the time of starting up and during an operation of the programmable display device 100₁, it is not necessary to interpret the project property data 502₁, and therefore processing loads become small.

The drawing software 201 includes the drawing data template 501 and the project-property aggregate data 502 corresponding to the plural programmable display devices 100₁ to 100ₙ.

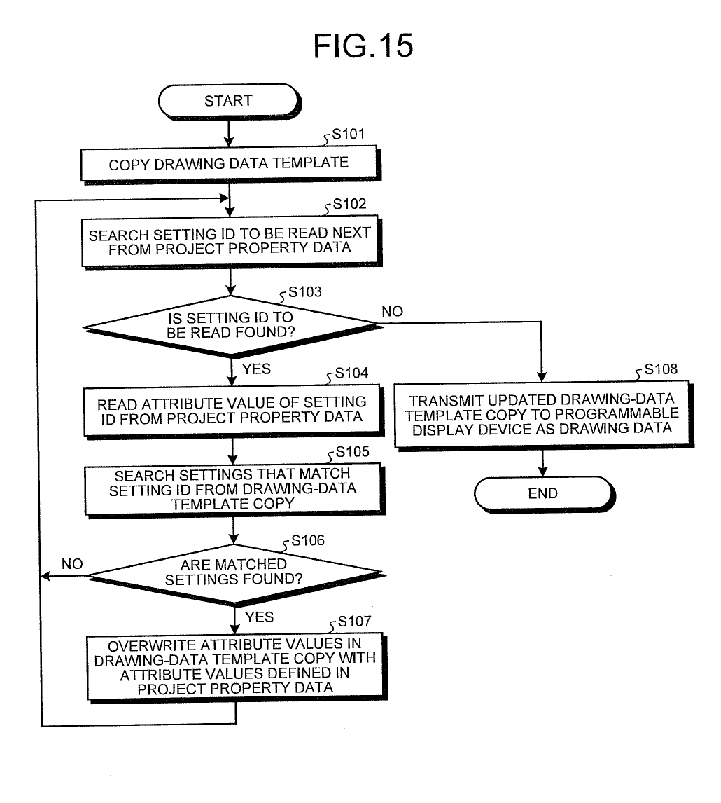

FIG. 15 depicts a processing flow in a case where the project property data 502₁ to 502ₙ are interpreted by the drawing software 201 and the drawing data 610₁ to 610ₙ are transmitted to the programmable display devices 100₁ to 100ₙ. When the drawing data 610₁ is transmitted to the programmable display device 100₁, the drawing data template 501 is copied to generate a drawing-data template copy 501₁ which becomes the basis of updated drawing data 610₁ (Step S101). The project-data interpreting unit 34 searches a setting ID to be read next from the project property data 502₁ of a designated Unit (Step S102). For example, searching of a setting ID is performed by reading the definitions in the project property data one by one from the beginning thereof and extracting the setting ID. When a setting ID to be read is found (YES at Step S103), the project-property data interpreting unit 34 reads attribute values of the setting ID from the project property data 502₁ of a designated Unit (Step S104). The project-property-data interpreting unit 34 further searches settings that match the setting ID of the attribute values read from the project property data 502₁ of the designated Unit from the drawing-data template copy 501₁ (Step S105). When matched settings are found (YES at Step S106), the project-property-data interpreting unit 34 overwrites the attribute values of the drawing-data template copy 501₁ with the attribute values defined in the project property data 502₁ of the designated Unit (Step S107), and then the process returns to Step S102. When there is no matched setting (NO at Step S106), the process returns to Step S102. As for the setting ID in this case, the attribute values in the drawing-data template copy 501₁ are used as they are as the attribute values of the drawing data 610₁.

When the setting ID to be read is not found (NO at Step S103), the edited drawing-data template copy 501₁ is transmitted to the programmable display device 100₁ as the drawing data 610₁ (Step S108) and then the process ends.

In the programmable display device 100₁, the control unit 10 operates based on the downloaded drawing data 610₁. In this case, the process performed by the programmable display device 100₁ is same as the conventional process of interpreting drawing data.

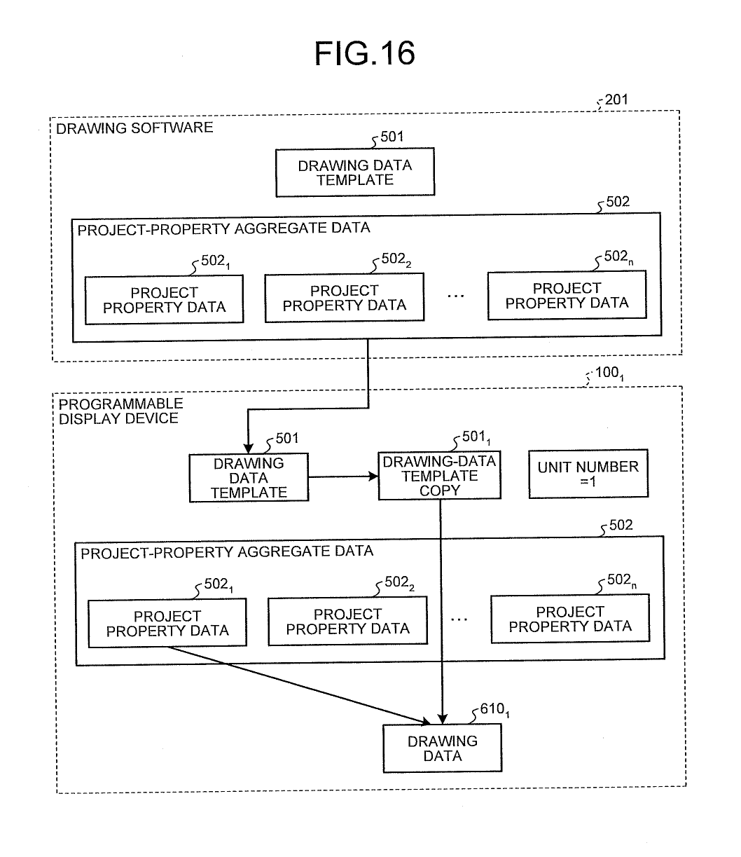

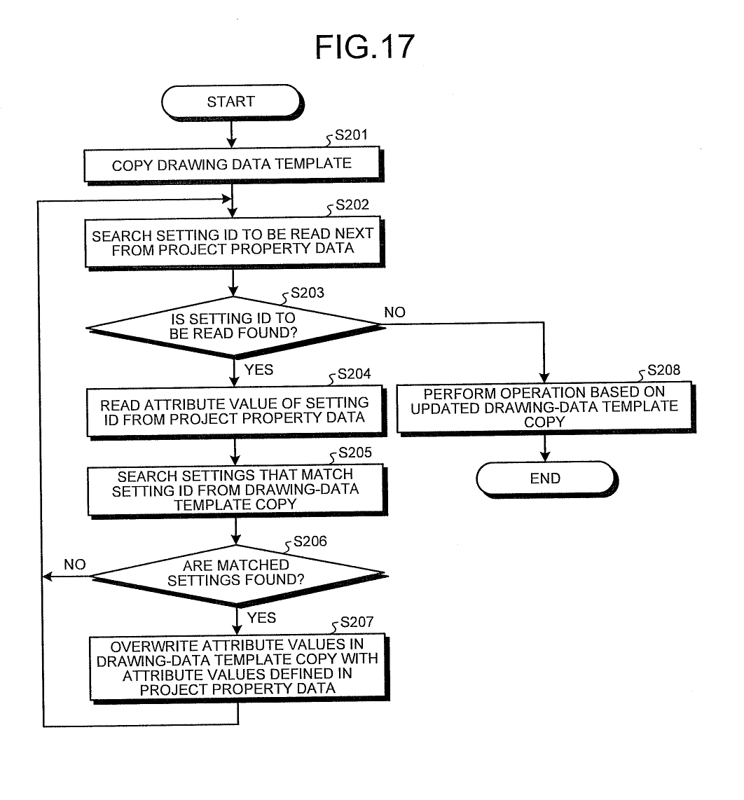

Meanwhile, when interpreting the project property data 502₁ to 502ₙ, the programmable display devices 100₁ to 100, can switch the drawing data dynamically depending on each Unit. FIG. 16 is a schematic diagram of a process in a case where the main unit of the programmable display device 100 interprets the project property data 502. The following explanation exemplifies a case where the project property data 502₁ is interpreted to create the drawing data 610₁ for the programmable display device 100₁. FIG. 17 depicts a processing flow in a case where the programmable display devices 100₁ to 100, interpret the project property data 502₁ to 502ₙ. A case where the programmable display device 100₁ interprets the project property data 502₁ is explained below. The drawing-data software 201 contains the drawing data template 501 and the project property data 502₁ to 502ₙ corresponding to the plural programmable display devices 100₁ to 100ₙ. When data is transmitted to the programmable display device 100₁, the drawing data template 501 and two or more elements of the project property data 502₁ to 502ₙ are transmitted.

When interpreting the project property data 502₁, the programmable display device 100₁ reads and copies the drawing data template 501, and generates the drawing-data template copy 501₁ which becomes the basis for the drawing data 610₁ to be executed (Step S201). The project-property-data interpreting unit 151 searches a setting ID to be read next, from the project property data 502₁ corresponding to a designated Unit out of the project property data 502₁ to 502ₙ (Step S202). When the setting ID to be read is found (YES at Step S203), the project-property-data interpreting unit 151 reads attribute values of the setting ID from the project property data 502₁ of the designated Unit (Step S204). The project-property-data interpreting unit 151 further searches from the drawing-data template copy 501₁, the settings that match the setting ID of the attribute values read from the project property data 502₁ of the designated Unit (Step S205). When matched settings are found (YES at Step S206), the project-property-data interpreting unit 151 overwrites the attribute values of the drawing-data template copy 501₁ with the attribute value defined in the project property data 502₁ of the designated Unit (Step S207), and then the process returns to Step S202. When there is no matched setting (NO at Step S106), the process returns to Step S202. As for the setting ID in this case, the attribute values of the drawing-data template copy 501₁ are used as they are as the attribute values of the drawing data 610₁.

When the setting ID to be read is not found (NO at Step S103), the control unit 10 uses the updated drawing-data template copy 501₁ as the drawing data 610₁, and operates the programmable display device 100 based on the drawing data 610₁ (Step S208), and then the process ends.

In this example, all the project property data 502₁ to 502ₙ are downloaded in the programmable display device 100₁; however, when the Unit number of the programmable display device 100 is specified, only the project property data 502₁ to 502ₙ of the specified Unit can be extracted and downloaded.

When plural elements of the project property data 502₁ to 502ₙ are stored in the programmable display devices 100₁ to 100ₙ, the operation of the programmable display devices 100₁ to 100ₙ can be switched according to the Unit number thereof.

When only one element among the project property data 502₁ to 502ₙ is stored in the programmable display devices 100₁ to 100ₙ, the operation of the programmable display devices 100₁ to 100ₙ can be switched only by replacing the project property data 502₁ to 502ₙ without any modification on the drawing data template 501 itself. That is, without using the drawing software 201, a general-purpose tool (a spreadsheet application and the like) is used for updating the project property data 502₁ to 502ₙ and the updated project property data 502₁ to 502ₙ are made to be interpreted by the project-data interpreting unit 15, by which the operation of the programmable display devices 100₁ to 100ₙ can be switched.

### Second Embodiment

Configurations of a project-data creating device and a programmable display device according to a second embodiment of the present invention are identical to those of the first embodiment. However, in the second embodiment, setting attributes of objects and functions are not defined, but combinations of screens and functions to be displayed on the programmable display device are defined by project property data.

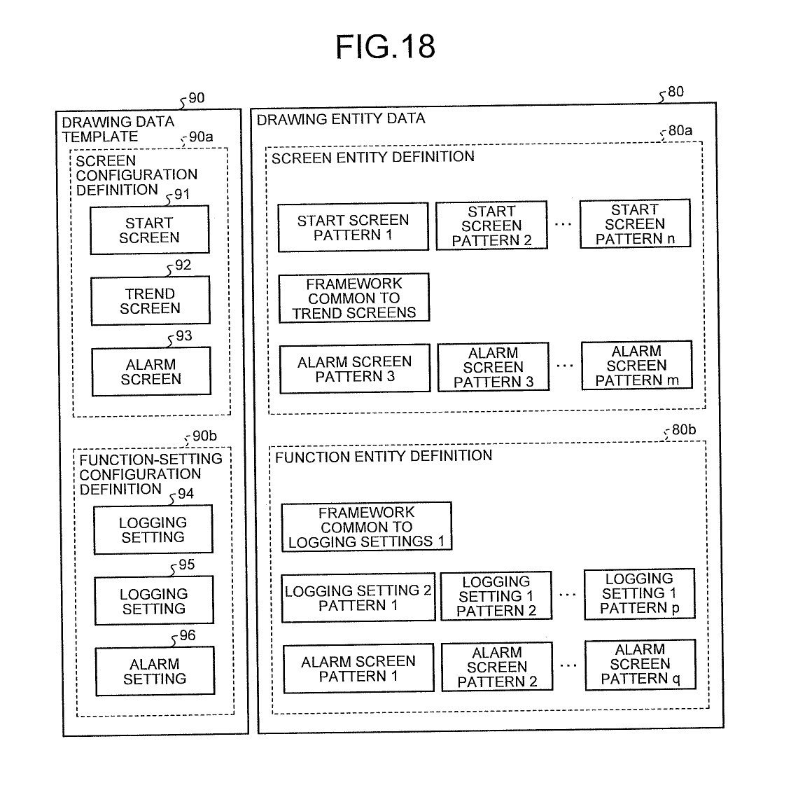

FIG. 18 depicts combinations of screens and functions displayed on the programmable display device 100. The programmable display device 100 has a function of displaying three screens, which are a start screen 91, a trend screen 92, and an alarm screen 93, a logging function for collecting and storing values of two devices, and an alarm function of monitoring and storing an alarming status of the device. Details of the function of logging the outputs from two devices are set as logging settings 94 and 95. Also, details of the alarm function are set as an alarm setting 96. Some of the start screen 91, the trend screen 92, the alarm screen 93, the logging settings 94 and 95, and the alarm setting 96 have a plurality of patterns of which contents are different, and have a framework common to respective Units of the programmable display devices 100.

The project-data interpreting unit 34 contains a drawing data template 90 used for specifying screens and functions by drawing entity data for each screen type and function type. In the drawing data template 90, the start screen 91, the trend screen 92, and the alarm screen 93 constitute a screen configuration definition 90a, and the logging settings 94 and 95 and the alarm setting 96 constitute a function-setting configuration definition 90b.

Drawing entity data 80 includes a screen entity definition 80a and a function entity definition 80b, and includes in advance necessary patterns of actual screens and various function settings. In FIG. 18, “start screen pattern 1” and other elements are shown in the screen entity definition 80a, and these elements are labels for specifying the entity of the screen. The same holds true for the function entity definition 80b. Any character strings can be assigned to each label, and also alphabets or numbers can be used in the same manner like in the first embodiment.

In the second embodiment, the entity of the screen applied in the screen configuration definition 90a is the screen entity definition 80a, and the entity of the function-setting configuration definition 90b is the screen entity definition 80b.

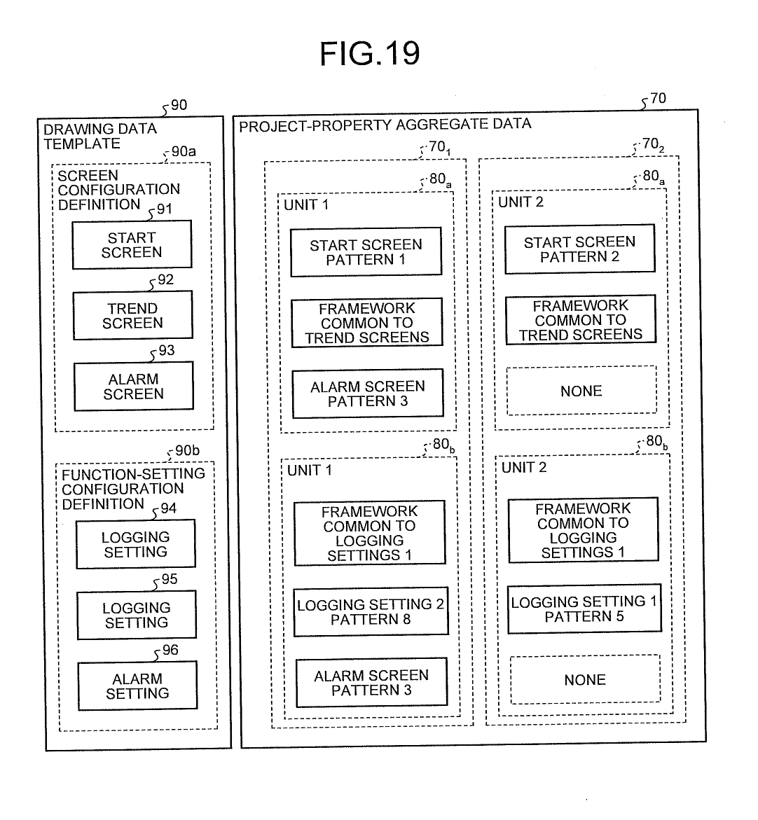

FIG. 19 is an example of project-property aggregate data 70. In the present embodiment, a combination of settings related to displayed screens and functions is set as project property data for respective Units. That is, in the project property data 70₁ and 70₂, a combination of the screen entity definition 80a corresponding to the screen configuration definition 90a and the function entity definition 80b corresponding to the function-setting configuration definition 90b is defined for each of the programmable display devices 100₂ and 100₂, respectively. For example, a correspondence in which “start screen pattern 1” is allocated as an entity to “start screen” in the screen configuration definition 90a is defined for respective Units to all the screens included in the screen configuration definition 90a and all the function items included in the function-setting configuration definition 90b.

For a screen or a function that is not present in a certain Unit, the screen entity definition 80a and the function entity definition 80b associated with constituent elements in each of the screen configuration definition 90a and the function-setting configuration definition 90b, respectively, can be defined as “none”. In FIG. 19, “alarm screen” and “alarm setting” of a Unit 2 have no associated entity.

The interpretation of the project property data in the second embodiment is different from that in the first embodiment in a feature that the screen entity definition 80a and the function entity definition 80b are applied to the screen configuration definition 90a and the function-setting configuration definition 90b, respectively. However, the first and second embodiments are identical in a feature that this process can be performed by any one of the project-property-data interpreting unit 341 and the project property data 151.

According to the second embodiment, only one drawing data is required to manage the screens and functions of plural programmable display devices in an integrated manner. That is, common data created as the screen entity definition and the function entity definition is reflected on respective Units on the screen configuration definition and the function configuration definition, and therefore, even when various types of screens are switchably displayed on the programmable display device, it is not necessary to create drawing data including the screens corresponding to each type thereof.

### INDUSTRIAL APPLICABILITY

As described above, the project-data creating device and the programmable display device according to the present invention are useful for a case in which there are a plurality of programmable display devices, which respectively have a substantially identical but partially different screen configuration to one another, and the project-data creating device and the programmable display device are particularly suitable for a case in which programmable display devices are installed on a production line of a factory and the like.

### REFERENCE SIGNS LIST

10, 30 CONTROL UNIT
11, 32 DISPLAY PROCESSING UNIT
12, 31 OPERATION PROCESSING UNIT
13 EXTERNAL-DEVICE-COMMUNICATION PROCESSING UNIT
14 HIGH-ORDER-COMMUNICATION PROCESSING UNIT
15, 34 PROJECT-DATA INTERPRETING UNIT
16 INPUT DEVICE
17 DISPLAY DEVICE
18, 43 COMMUNICATION I/F
19 INTERNAL STORAGE MEDIUM
20 EXTERNAL STORAGE I/F
21, 44 FILE SYSTEM
33 COMMUNICATION PROCESSING UNIT
41 INPUT DEVICE
42 DISPLAY
45 CPU
46 MEMORY
51, 52 NUMERICAL-VALUE DISPLAY COLUMN
53 HISTORICAL TREND GRAPH
54 LEFT-SCROLL SWITCH
55 RIGHT-SCROLL SWITCH
56 SCREEN
100, 100₁ to 100ₙ, 800₁ to 800ₙ PROGRAMMABLE DISPLAY DEVICE
151, 341 PROJECT-PROPERTY-DATA INTERPRETING UNIT
200 COMPUTER
201 DRAWING SOFTWARE
500 PROJECT DATA
501, 630 DRAWING DATA TEMPLATE
502 PROJECT-PROPERTY AGGREGATE DATA
502₁ to 502ₙ PROJECT PROPERTY DATA
600 DRAWING DATA TEMPLATE
601₁ to 601ₙ, 630 DRAWING DATA
650 GENERAL-PURPOSE EDITOR
700₁ to 700ₙ PRODUCTION APPARATUS

1. A project-data creating device that creates project data that is a basis of drawing data for causing a programmable display device to display a screen including an object and to operate a background function, the device comprising:
a unit that creates a drawing data template including a setting ID and a predetermined attribute name, the setting ID being set for each of the object and the background function included in the drawing data, the predetermined attribute name being set for each attribute value of the object and the background function;
a unit that creates project property data including immediate data that corresponds to the attribute name set for each attribute value of the object and the background function corresponding to the setting ID; and
a unit that transmits the drawing data template and the project property data to the programmable display device as the project data.

2. The project-data creating device according to claim 1, further comprising:
a project-property-data interpreting unit that creates drawing data by replacing the attribute name set in the drawing data template with the immediate data set in the project property data; and
a unit that transmits the drawing data created by the project-property-data interpreting unit to the programmable display device.

3. The project-data creating device according to claim 2, further comprising a unit that stores therein a table indicating a correspondence between immediate data corresponding to the attribute name and a label, wherein
the project-property-data interpreting unit refers to the table and replaces the attribute value of the attribute name for which the label has been set instead of the immediate data in the project property data with the immediate data.

4. The project-data creating device according to claim 1, further comprising:
a unit that exports the project property data in a file format that is editable by a general-purpose editor; and
a unit that imports the project property data from the general-purpose editor.

5. A project-data creating device that creates project data that is a basis of drawing data for causing a programmable display device to display a screen including an object and to operate a background function, the device comprising:
a unit that creates a drawing data template including a screen configuration definition for defining a type of a screen including the object and a function-setting configuration definition for defining a type of the background function;
a unit that creates project property data that specifies an entity of a screen including the object, the type of which being defined in the screen configuration definition, and an entity of the background function, the type of which being defined in the function-setting configuration definition; and
a unit that transmits the drawing data template and the project property data to the programmable display device as the project data.

6. The project-data creating device according to claim 5, further comprising:
a project-property-data interpreting unit that creates the drawing data by reflecting a screen and a function specified in the project property data on the drawing data template; and
a unit that transmits the drawing data created by the project-property-data interpreting unit to the programmable display device.

7. A programmable display device that displays an object and operates a background function by executing drawing data, the device comprising:
an internal storage medium that stores therein a drawing data template and project property data, the drawing data template including a setting ID and a predetermined attribute name, wherein the setting ID is set for each of the object and the background function included in the drawing data, and the predetermined attribute name is set for each attribute value of the object and the background function, and wherein the project property data includes immediate data corresponding to the attribute name set for each attribute value of the object and the background function corresponding to the setting ID; and
a project-property-data interpreting unit that creates drawing data by replacing the attribute name set in the drawing data template with the immediate data set in the project property data.

8. The programmable display device according to claim 7, wherein the project-property-data interpreting unit generates a copy of the drawing data template stored in the internal storage medium, and reflects the attribute value set in the project property data on the copy of the drawing data template.

9. A programmable display device that displays an object and operates a background function by executing drawing data, the device comprising:
an internal storage medium that stores therein a drawing data template and project property data, wherein the drawing data template includes a screen configuration definition for defining a type of a screen including the object to be set and a function-setting configuration definition for defining a type of the background function to be set, and the project property data specifies an entity of a screen including the object, the type of which being defined in the screen configuration definition, and an entity of the background function, the type of which being defined in the function-setting configuration definition; and
a project-property-data interpreting unit that reflects a screen including the object and the background function specified in the project property data on the drawing data template.
